(19) United States
(12) Patent Application Publication
(10) Pub. No.: US 2001/0040044 A1
(43) Pub. Date: Nov. 15, 2001

(54) ELECTRICAL CABLE APPARATUS HAVING IMPROVED FLAME RETARDANCY AND METHOD FOR MAKING

(76) Inventors: PRIYA L. TABADDOR, ALPHARETTA, GA (US); PRIYA L. TABADDOR, ALPHARETTA, GA (US); VENKATESH VASUDEVAN, NORCROSS, GA (US)

Correspondence Address: David P. Kelley, THOMAS KAYDEN HORSTEMEYER & RISLEY, L.L.P., 100 Galleria Parkway, Suite 1500, ATLANTA, GA, 30339, US

(21) Appl. No.: 09/406,177

(22) Filed: Sep. 24, 1999

(51) Int. Cl. H01B 7/00

(52) U.S. Cl. 174/121 A

(57) ABSTRACT

Embodiments of the invention include an electrical cable apparatus and method for making. The electrical cable comprises a plurality of paired conductive elements such as twisted pairs of individually insulated copper wire, a flame retardant yarn layer formed or wrapped helically around the conductor pairs or groups of conductor pairs, and a dielectric jacket formed around the conductive pairs and the yarn layer(s). The yarn layer is formed or wrapped around individual conductor pairs or, alternatively, around groups of conductor pairs. The yarn layer is made of, e.g., glass yarn, non-woven glass yarn tape, polyimides such as Kapton® tape, polyaramid yarns such as Kevlar® and Nomex®, or other suitable flame retardant materials and/or material combinations. The method for making the electrical cable comprises providing a plurality of paired conductive elements, forming a flame retardant yarn layer around the conductor pairs or around groups of conductor pairs, and forming a dielectric jacket around the conductor pairs and yarn layers. During bum conditions, the flame retardant yarn layer wicks melted insulation from the individual insulated conductor pair elements to reduce the likelihood of melted insulation pooling in the cable and breaching the dielectric jacket of the cable. Also, various yarn layer arrangements maintain separation of the conductor pairs within the cable for reduced crosstalk.

### BACKGROUND OF THE INVENTION

1. Field of the Invention

The invention relates to electrical cabling. More particularly, the invention relates to electrical cabling having improved flame retardancy and reduced crosstalk.

2. Description of the Related Art

Electrical communication cables typically are comprised of a plurality of twisted pair of individually insulated, electrically conductive elements such as copper wires and a protective, insulating jacket surrounding the group of conductive element pairs. In addition to exhibiting sufficient transmission characteristics, electrical communication cables used for indoor applications typically have flame retardancy and low smoke requirements. Electrical communication cables having insulation materials formed from fluoropolymers must pass standardized fire tests, e.g., the Underwriter's Laboratory Standard 910 test (commonly referred to as the Steiner Tunnel test) or NFPA 262, which qualifies these cables for use in a plenum space inside buildings.

Examples of fluoropolymer insulation materials used in electrical communication cables include, e.g., fluoroethylenepropylene (FEP), ethylenechlorotrifluoroethylene (ECTFE), perfluoroalkoxy polymers (PFA) and polytetrafluoroethylene (PTFE). For example, Teflon® is one type of FEP material often used as insulation for the individual wires forming the twisted pairs because of its advantageous electrical transmission properties, and favorable flame retardant and low smoke producing characteristics. Similarly, Halar® is one type of ECTFE material used in the cable jacket.

In addition to exhibiting favorable bum characteristics, electrical communication cables also should maintain excellent transmission properties. For example, Category 5 communication cables (i.e., cables capable of handling signals up to 100 MHz) typically perform to industry-set standards in several transmission performance areas, including, e.g., attenuation, impedance, crosstalk and structural return loss (SRL).

As the evolution of electrical communication cables continues, it is desirable to have an electrical communication cable with improved burn and low smoke properties while maintaining suitable transmission characteristics.

### SUMMARY OF THE INVENTION

The invention is embodied in an electrical cable apparatus and method for making. The electrical cable comprises a plurality of paired conductive elements such as twisted pairs of individually insulated copper wires, one or more flame retardant yarn layers formed or wrapped helically around the conductor pairs or groups of conductor pairs, and a dielectric jacket formed around the conductive pairs and the yarn layer. In one embodiment, the yarn layer is formed or wrapped around individual conductor pairs. In alternative embodiments, the yarn layer is formed or wrapped around groups of conductor pairs, including the group of all conductor pairs in the cable. The yarn layer is made of, e.g., glass yarn, non-woven glass yarn tape, polyimides such as Kapton® tape, polyaramid yarns such as Kevlar® and Nomex®, or other suitable flame retardant materials and/or material combinations. The conductor pairs are individually insulated with, e.g., fluoroethylenepropylene (FEP) or other suitable insulating material. The dielectric jacket is made of, e.g., one or more materials selected from the group consisting of a fluoropolymer, polyvinyl chloride, polyolefin or other suitable polymers.

According to embodiments of the invention, a method for making an electrical cable comprises providing a plurality of paired conductive elements, forming a flame retardant yarn layer around the conductor pairs or around groups of conductor pairs, and forming a dielectric jacket around the conductor pairs and yarn layers. The yarn layer is wrapped helically or otherwise formed completely around the conductor pairs. Also, alternatively, a single yarn layer is formed around all the conductor pairs in the cable.

According to embodiments of the invention, the flame retardant yarn layer formed around the conductor pairs or groups of conductor pairs absorbs or wicks melted insulation from the individually insulated conductor pair elements during burn conditions, and thus reduces the likelihood of melted insulation pooling in the cable and breaching the dielectric jacket of the cable, which exposes the interior surface of the jacket to the flame and causes it to burn and smoke. Also, many embodiments of the invention include yarn layer arrangements that maintain separation of the conductor pairs within the cable and thus promote reduced crosstalk.

### BRIEF DESCRIPTION OF THE DRAWINGS

In the drawings:

FIG. 1 is a cross-sectional view of an electrical cable according to a conventional arrangement;

FIGS. 2a is a cross-sectional view of an electrical cable according to an embodiment of the invention;

FIGS. 2b is a cross-sectional view of a portion of the electrical cable of FIG. 2a showing an individually insulated conductor pair;

FIGS. 3a-b are partial, cross-sectional views of a portion of an electrical cable according to alternative embodiments of the invention;

FIG. 4 is a cross-sectional view of an electrical cable according to another alternative embodiment of the invention;

FIG. 5 is a simplified block diagram of a method for making an electrical cable according to embodiments of the invention; and

FIG. 6 is a partial, cross-sectional view of a yarn payoff for winding yarn around conductor elements according to embodiments of the invention.

### DETAILED DESCRIPTION

In the following description similar components are referred to by the same reference numeral in order to enhance the understanding of the invention through the description of the drawings.

Although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

Electrical communication cables typically comprise a plurality of paired conductive elements such as twisted pairs of copper wire having insulation for the individual wires forming the pairs and a protective, dielectric jacket surrounding the group of conductive pairs. Electrical cables for use, e.g., as plenum cables, and for other indoor applications typically have flame retardancy and low smoke requirements, as set by a competent authority such as the Underwriters Laboratory Incorporated or Intertek Testing Services. For example, cables passing the UL-910 test (also known as the Steiner Tunnel test) are considered plenum rated.

Because of the UL-910 burn test requirements, many plenum cables use, e.g., fluoropolymer materials for individually insulating the copper wires or other conductive elements that form the twisted pairs. Such materials include, e.g., fluoroethylenepropylene (FEP), ethylenechlorotrifluoroethylene (ECTFE), perfluoroalkoxy polymers (PFA) and polytetrafluoroethylene (PTFE). Teflon® is one type of FEP often used for individual wire insulation in plenum cables because it is relatively flame retardant and produces relatively low smoke during burn conditions. Dielectric jacket materials for plenum cables include, e.g., ethylenechlorotrifluoroethylene (ECTFE) and low smoke polyvinyl chloride (LSPVC). Halar® is one type of ethylenechlorotrifluoroethylene (ECTFE) used in the cable jacket.

Embodiments of the invention are based on the advantageous realization that the formation and use of glass yarns and other suitable materials around one or more pairs of conductive elements within an electrical cable improves the bum characteristics of the cable without significantly sacrificing transmission performance. Although not wishing to be bound by theory, it is believed that, during burn conditions, the insulation (e.g., FEP) surrounding the copper wires melts off and pools in the cable and actually breaches the dielectric (e.g., PVC) jacket. Thus, the interior surface of the jacket is exposed to the flame, which causes it to burn and produce. Such behavior occurs especially in cables having relatively large numbers of insulated conductor pairs, e.g., 25-pair cables. Embodiments of the instant invention reduce FEP pooling by using flame retardant yarns such as glass yarn around the twisted wire pairs or groups of twisted wire pairs. The glass yarn wicks the FEP during bum conditions, reducing FEP pooling and preserving the dielectric jacket from exposing its interior surface to the flame.

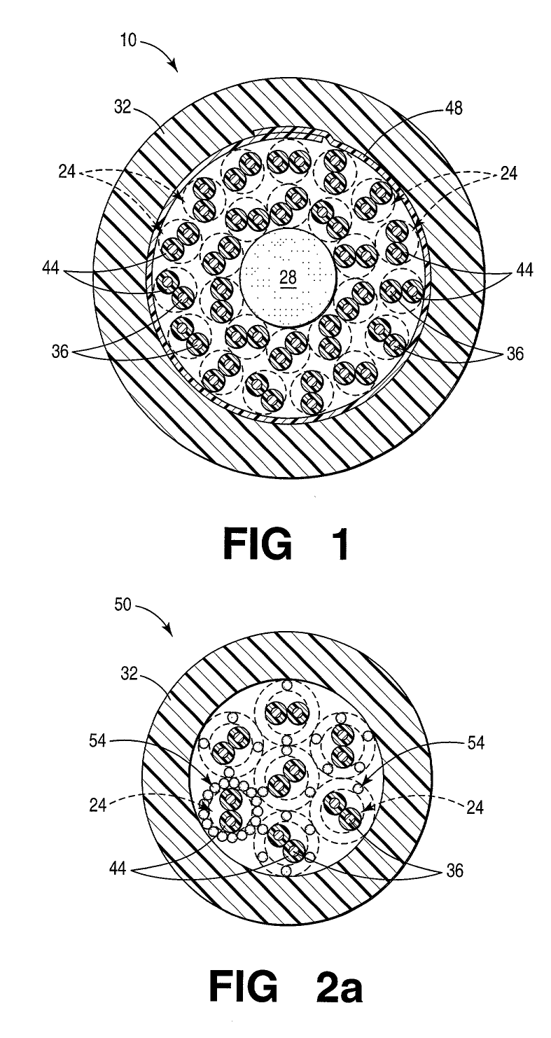

At least one conventional electrical cable makes use of glass yarn. However, its use is not in the advantageous manner of embodiments of the instant invention. For example, FIG. 1 shows an electrical cable 10 according to a conventional arrangement. The cable 10 comprises a plurality of pairs of conductors (shown generally as dashed line 24) positioned around a central fiberglass yarn core 28 and surrounded by a dielectric jacket 32. The conductor pairs 24 include, e.g., copper wires 36 individually insulated with a layer 44 of, e.g., FEP or other suitable material. The dielectric jacket 32 is made of, e.g., low smoke polyvinyl chloride (LSPVC) or other suitable material. Also, a polyester tape 48 wraps around the plurality of twisted pairs 24.

The yarn core 28 provides sufficient structure for the conductor pairs 24, especially in electrical cables having a relatively large number of conductor pairs (e.g., 25 pairs). Also, the core 28 and the dielectric jacket 32 are dimensioned appropriately to maintain the positioning of the conductor pairs 24 therebetween. During bum conditions, the core 28 may provide some wicking of melted FEP. However, perhaps because the core 28 is a single element “inside” of the FEP-insulated conductor pairs 24, the wicking by the core 28 of melted FEP is probably not optimal.

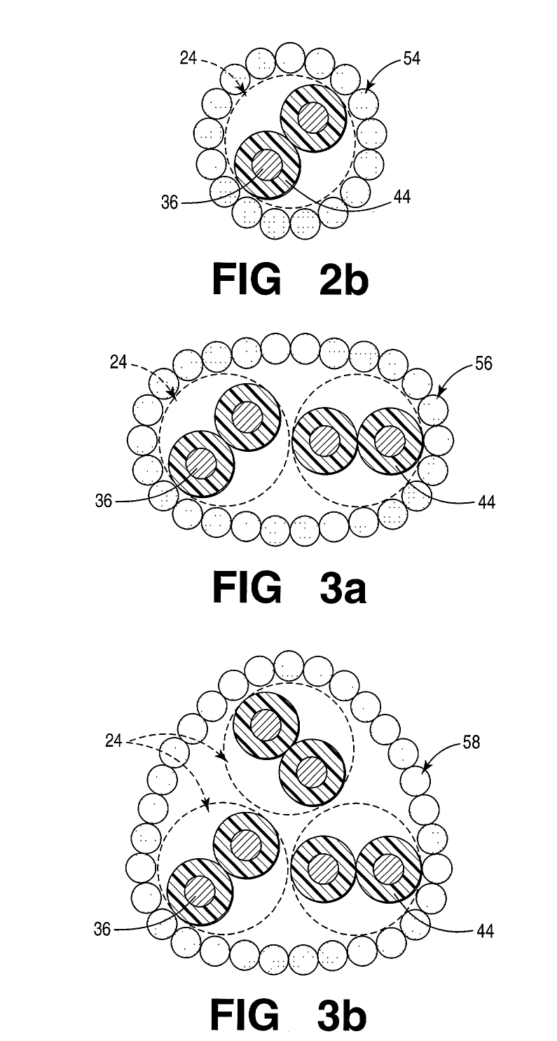

Referring now to FIGS. 2a-b, an electrical cable 50 according to an embodiment of the invention is shown. The inventive cable 50 comprises a plurality of pairs of conductors 24, a flame retardant yarn layer 54 wrapped around or otherwise surrounding individual conductor pairs 24, and a dielectric jacket 32 surrounding the plurality of yarn-wrapped conductor pairs 24. Although only eight conductor pairs are shown in FIG. 1a, it is possible for the inventive cable 50 to include any suitable number of conductor pairs, e.g., 25 conductor pairs. Similar to the conductor pairs as shown and described in FIG. 1, the conductor pairs 24 in FIGS. 2a-2b include, e.g., copper wires 36 individually insulated with a layer 44 of, e.g., FEP or other suitable insulating material. Also, the dielectric jacket 32 is made of, e.g., low smoke polyvinyl chloride (LSPVC) or other suitable material, and is formed around the conductor pairs by, e.g., extrusion molding or other appropriate process.

However, according to embodiments of the invention, the flame retardant yarn layers 54 are wrapped or otherwise formed around individual conductor pairs 24, rather than having a single yarn core region (i.e., core 28 in FIG. 1) around which the conductor pairs are positioned. According to embodiments of the invention shown in FIGS. 2a-2b, flame retardant yarn is distributed throughout the cable at locations where individual conductor pairs are located. Thus, during a burn condition, melted FEP from the individual conductor pairs 24 is more efficiently wicked by the respective yarn layer 54 than in conventional arrangements. Also, because glass yarn is an adequate dielectric, the particular configurations of glass yarn layers 54 around conductor pairs 24 according to embodiments of the invention provide better separation between conductor pairs 24 than, e.g., the conventional arrangement shown in FIG. 1 and previously discussed. Referring again to embodiments of the invention shown in FIGS. 2a-b, the yarn used in the yarn layer 54 is made of, e.g., glass yarn, non-woven glass yarn tape, polyimides such as Kapton® tape, polyaramid yarns such as Kevlar® and Nomex®, or other suitable flame retardant materials and/or material combinations. According to an embodiment of the invention, the yarn layer 54 is wound helically around the individual conductor pair 24. Alternatively, the yarn layer 54 is formed completely around the individual conductor pair 24. As will be discussed in greater detail hereinbelow, the yarn layer 54 is applied, e.g., by a yarn payoff device or by any other suitable technique.

Although FIGS. 2a and 2b show a flame retardant yarn layer 54 wrapped or otherwise formed around individual conductor pairs 24, alternative embodiments of the invention include wrapping or otherwise forming a flame retardant yarn layer around a group of more than one conductor pair 24. For example, as shown partially in FIG. 3a, a single yarn layer 56 is wrapped or otherwise formed around two conductor pairs 24. Similarly, as shown partially in FIG. 3b, according to another alternative embodiment of the invention, a single yarn layer 58 is wrapped or otherwise formed around three conductor pairs 24. Accordingly, in this manner, it is possible to form a yarn layer around any logical number of conductor pairs.

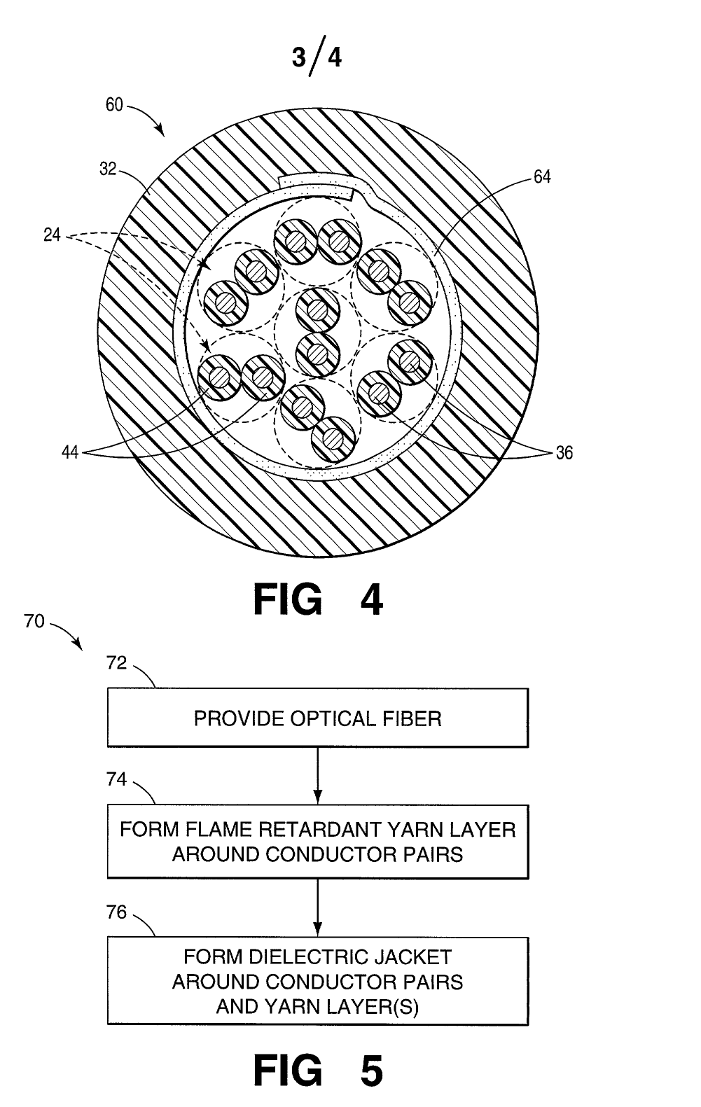

Referring now to FIG. 4, an electrical cable 60 according to another embodiment of the invention is shown. In this embodiment, the electrical cable 60 comprises a plurality of pairs of conductors 24, a flame retardant yarn layer 64 surrounding or formed around the conductor pairs 24, and a dielectric jacket 32 surrounding the yarn layer 64. Similar to previous embodiments, the conductor pairs 24 include, e.g., copper wires 36 individually insulated with a layer 44 of, e.g., FEP or other suitable material, and the dielectric jacket 32 is made of, e.g., low-smoke PVC or other suitable material.

In this embodiment, the yarn layer 64 is, e.g., a non-woven glass yarn tape and/or a Kapton tape formed around the entire group of conductor pairs 24. In this configuration, the glass yarn layer 64 provides a wicking region between the dielectric jacket 32 and the FEP insulation 44 on the copper wires 36. The Kapton tape provides protection by adding to the strength of the characteristic formed by the jacket, thus preventing the jacket from splitting open. During burn conditions, at least a portion of any melting FEP should be absorbed or wicked by the glass yarn layer 64 before the FEP has a chance to pool and collectively breach a portion of the dielectric jacket 32.

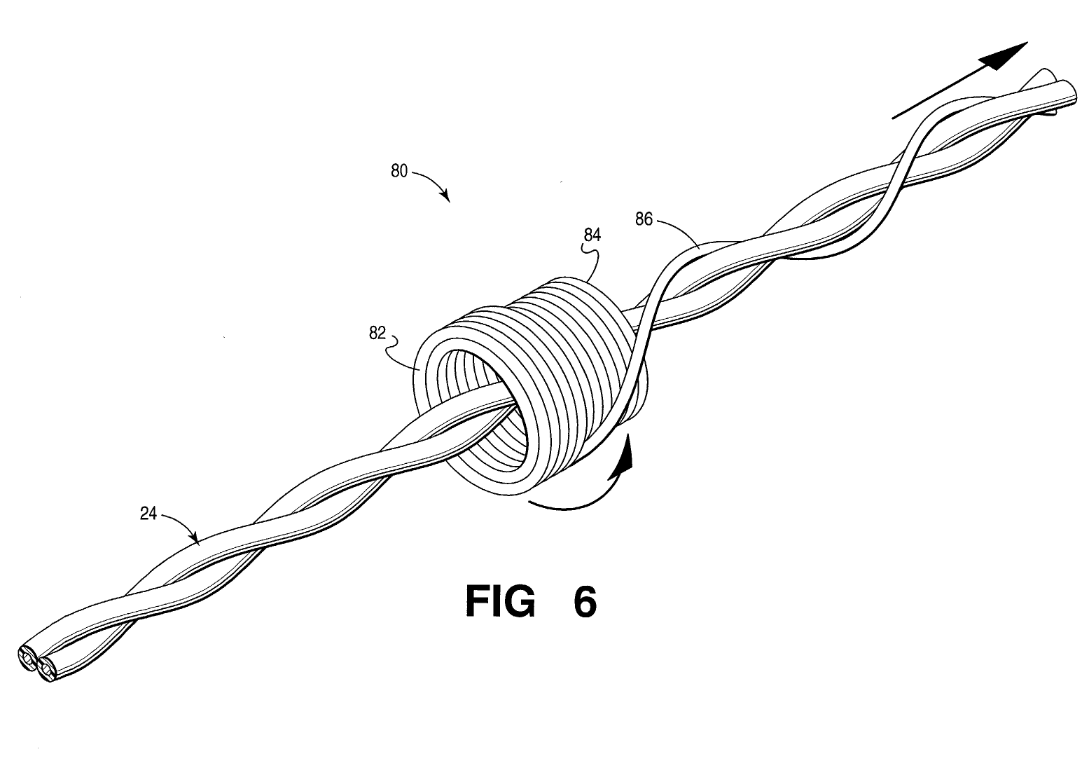

Referring now to FIG. 5, shown is a simplified block diagram of a method 70 for making an electrical cable according to embodiments of the invention. The method 70 includes a first step 72 of providing a plurality of paired conductor elements, e.g., a plurality of twisted pair of individually insulated copper wires, as discussed hereinabove.

The next step 74 is to form a flame retardant glass yarn layer around at least one conductor pair or at least one group of conductor pairs. For example, according to one embodiment of the invention, the glass yarn layer forming step 74 forms a glass yarn layer around individual conductor pairs. According to alternative embodiments of the invention, the glass yarn layer forming step 74 forms a glass yarn layer around various groups of conductor pairs, e.g., groups of two conductor pairs, groups of three conductor pairs, groups of five connector pairs, groups of ten conductor pairs. Also, according to another embodiment of the invention, the glass yarn layer forming step 74 forms a single glass yarn layer around the entire group of conductor pairs.

As discussed previously herein, the glass yarn layer or layers are, e.g., wrapped helically around the conductor pair or pairs of interest and/or are formed to completely or partially surround the conductor pair or pairs of interest. For example, the conductor pair or pairs of interest pass through a glass yarn payoff, e.g., the glass yarn payoff 80 shown in FIG. 6.

The glass yarn payoff 80 has a first or front end 82 through which a conductor pair 24 or group of conductor pairs enters, and a second or back end 84 through which the conductor pair 24 exits. As the conductor pair 24 passes through the glass yarn payoff 80, glass yarn (shown generally as 86) is payed off from the glass yarn payoff 80 and, e.g., wrapped helically around the conductor pair 24. As the conductor pair 24 exits the second end 84 of the glass yarn payoff 80, the helical wrap of glass yarn around the conductor pair is complete.

The next step 76 is to form a dielectric jacket around the conductor pairs and the glass yarn layer(s). That is, according to one embodiment of the invention, a glass yarn layer is formed helically around individual conductor pairs or groups of conductor pairs. In such arrangement, the dielectric jacket is formed around the conductor pairs and their respective helical glass yarn layer. See, e.g., the cable 50 in FIGS. 2a-2b and 3a-3b. Alternatively, according to other embodiments of the invention, a glass yarn layer is formed to surround the entire group of conductor pairs. In such arrangement, the dielectric jacket is formed around the glass yarn layer. See, e.g., the cable 60 in FIG. 4.

As discussed hereinabove, embodiments of the invention wrap or otherwise form a flame retardant glass yarn layer around conductor pairs or groups of conductor pairs within an electrical communication cable. The arrangements according to embodiments of the invention are advantageous in that, during burn conditions, the glass yarn layers absorb or wick melted insulation from the individual insulated conductor pair elements, e.g., FEP insulation, and thus prevent the melted insulation from pooling in the cable and possibly breaching the cable's outer dielectric jacket. Also, the glass yarn layer or layers in several cable arrangements according to embodiments of the invention maintain separation of the conductor pairs within the cable and thus promote reduced crosstalk therebetween.

It will be apparent to those skilled in the art that many changes and substitutions can be made to the embodiments of the electrical cables herein described without departing from the spirit and scope of the invention as defined by the appended claims and their full scope of equivalents.

What is claimed is:

1. An electrical cable, comprising:
a plurality of paired conductive elements, wherein at least a portion of the plurality of paired conductive elements are part of at least one group of paired conductive elements;
a flame retardant yarn formed around at least one group of paired conductive elements; and
a dielectric jacket formed around the plurality of paired conductive elements and the flame retardant yarn.

2. The electrical cable as recited in claim 1, wherein the flame retardant yarn is made of one or more materials selected from the group consisting of glass yarn, non-woven glass yarn tape, polyimides, and polyaramid yarns.

3. The electrical cable as recited in claim 1, wherein the groups of paired conductive elements further comprise a single twisted pair of conductive elements, and wherein the flame retardant yarn is formed around the single twisted pair of conductive elements.

4. The electrical cable as recited in claim 1, wherein the groups of paired conductive elements further comprise a single group of paired conductive elements, and wherein the flame retardant yarn is formed around the single group of paired conductive elements.

5. The electrical cable as recited in claim 1, wherein the flame retardant yarn is wound helically around at least one of the plurality of paired conductive elements.

6. The electrical cable as recited in claim 1, wherein the plurality of paired conductive elements further comprises a plurality of twisted pairs of individually insulated copper wires.

7. The electrical cable as recited in claim 6, wherein the twisted pairs of individually insulated copper wires are insulated with one or more materials selected from the group consisting of fluoroethylenepropylene (FEP), ethylenechlorotrifluoroethylene (ECTFE), perfluoroalkoxy polymers (PFA) and polytetrafluoroethylene (PTFE).

8. The electrical cable as recited in claim 1, wherein the dielectric jacket includes one or more materials selected from the group consisting of a fluoropolymer, polyvinyl chloride, and a polyolefin.

9. An electrical cable, comprising:
at least one twisted pair of conductive elements, wherein the twisted pair of conductive elements includes a flame retardant yarn formed therearound; and
a dielectric jacket formed around the at least one twisted pair of conductive elements.

10. The electrical cable as recited in claim 9, wherein the flame retardant yarn is made of one or more materials selected from the group consisting of glass yarn, nonwoven glass yarn tape, polyimides, and polyaramid yarns.

11. The electrical cable as recited in claim 9, wherein the flame retardant yarn is wound helically around the at least one group of paired conductive elements.

12. An electrical cable, comprising:
at least one group of at least one twisted pair of conductive elements;
a flame retardant yarn layer formed around the at least one group of at least one twisted pair of conductive elements; and
a dielectric jacket formed around the flame retardant yarn and the at least one group of at least one twisted pair of conductive elements.

13. The electrical cable as recited in claim 12, wherein the flame retardant yarn is made of one or more materials selected from the group consisting of glass yarn, nonwoven glass yarn tape, polyimides, and polyaramid yarns.

14. The electrical cable as recited in claim 12, wherein the flame retardant yarn is wound helically around the at least one group of paired conductive elements.

15. The electrical cable as recited in claim 12, wherein the at least one group of at least one twisted pair of conductive elements further comprises four twisted pair of conductive elements.

16. A method for making an electrical cable, comprising the steps of:
providing a plurality of paired conductive elements;
forming a layer of flame retardant yarn around at least one pair of conductive elements; and
forming a dielectric jacket around the plurality of paired conductive elements and the flame retardant yarn.

17. The method as recited in claim 16, wherein the paired conductive elements further comprise twisted pairs of conductor elements, and wherein the flame retardant yarn forming step further comprises forming a flame retardant yarn around individual twisted pairs of conductor elements.

18. The method as recited in claim 16, wherein the flame retardant yarn forming step further comprises forming a flame retardant yarn around the plurality of paired conductor elements, and wherein the dielectric jacket forming step further comprises forming a dielectric jacket around the flame retardant yarn layer.

19. The method as recited in claim 16, wherein the plurality of paired conductive elements further comprises at least one group of at least one twisted pair of conductive elements, and wherein the flame retardant yarn forming step further comprises forming a flame retardant yarn around at least one of the groups of twisted pairs of conductive elements.

20. The method as recited in claim 16, wherein the flame retardant yarn forming step further comprises passing at least one conductive element through a passive payoff of flame retardant yarn, wherein the flame retardant yarn winds helically around the at least one conductive element as the at least one conductive element passes through the payoff.

21. The method as recited in claim 16, wherein the dielectric jacket forming step further comprises extrusion molding.
